(19) United States
(12) Patent Application Publication
(10) Pub. No.: US 2003/0005644 A1
(43) Pub. Date: Jan. 9, 2003

(54) Adjustable door with sealed threshold, hinge and frame

(76) Inventors: Joseph Guy Reithmeyer, Afton, MN (US); Brian John Babka, Hudson, WI (US); Todd William Bruchu, Lake Elmo, MN (US)

Correspondence Address: MERCHANT & GOULD PC, P.O. BOX 2903, MINNEAPOLIS, MN, 55402-0903, US

(21) Appl. No.: 09/900,442

(22) Filed: Jul. 6, 2001

(51) Int. Cl. E06B 1/70

(52) U.S. Cl. 49/467; 49/471

(57) ABSTRACT

An entryway door system comprising a frame and a door slab positioned to move from an open to a closed position on a hinge installed in the frame. At least the hinge side and bottom having weather-strip segments cooperating with a threshold member to provide a weather tight seal.

### FIELD OF THE INVENTION

The invention relates to a hinged exterior entryway door system comprising a door slab, a frame and threshold. The hinged door slab can be moved from an open and closed position on the hinge structure. The door slab, when closed seals the system from the penetration of weather using a peripheral weather strip that contact at least sides and bottom of the door, the door system additionally comprising a threshold for providing a mounting location for the weather strip and providing structure, integrity and service life to the door system. The threshold provides mating surfaces that interact with the rough opening to seal the structure to the penetration of weather and rain.

### BACKGROUND OF THE INVENTION

The design and manufacture of exterior entry way door systems have posed serious problems to engineers designing systems that can be efficiently manufactured but can maintain excellent weather resistance and long useful life. Improperly sealed entry doors can permit migration of water, wind and cold weather from the exterior to the interior of the door often at the interface between the door and threshold, but also often at the peripheral side edges and the head of the door. Additionally, poorly designed thresholds can fail to prevent wind driven penetration of water through the threshold system into the interior of the door. These sealing problems are made worse in light of the doorframes and slabs that can often be poorly aligned or are out of plumb or out of square. Such frames or doors are without accurate 90° angles at the corners of the door and frame systems that do not match the planarity or shape of the door. Various attempts have been made to improve weather resistance of entry doors, to collect and drain environmental water from the threshold to provide weather stripping, adjustable threshold seals and other remedies to the design problems.

These problems with entryway door systems are made worse over time. As the doors are used, the adjustable members of the doors are manipulated into maintaining a weather seal, the door systems often can fail to achieve resistance to rot, prevent slab and frame binding, prevent weather penetration, adequately deal with water management, or other failure. These failures arise from the inability of the door to adapt to changing conditions over their useful lifetime. We have found that proper door adjustment and water management are essential features in entryway door design. Water contacting the system must be managed by the entryway door system so any water that penetrates the system collects within a threshold tank and is permitted to drain to the exterior of the door. Further, the construction of the entryway should prevent substantial damaging contact between water sensitive structures and water during periods of inclement weather. Lastly, the adjustability of the door should be maintained during its useful life to ensure that the door is maintained and sealed to penetration over its useful life.

Suggested solutions to such problems are shown in Oftedal et al., U.S. Pat. Nos. 2,108,137 and 2,167,958; Miller, U.S. Pat. No. 2,696,028; Erkkila, U.S. Pat. No. 2,875,418; Tibbets, U.S. Pat. No. 3,851,420; Bush, U.S. Pat. No. 3,900,967; Procter, U.S. Pat. No. 5,943,825 and others. Such structures include conventional weather strip sweep and adjustable thresholds, one piece extruded bases as a threshold, and other design systems.

We believe that these and other suggested solutions for improving entry door systems continue to fail to achieve the high standards required in residential real estate construction at installation and during the design useful life of the system. Many of the problems that remain to be solved in such construction include providing an adequate weather strip that can maintain an adequate barrier to the entry or penetration of weather from the exterior to the interior of a house over an extended period. Further, many of the adjustable door systems, for example, a vertically movable seal, either fails to adjust after a few years of use or is difficult to use or adjust. Further, many entry door systems permit or cause substantial water contact with framing members and resulting rot or deterioration. Lastly, many threshold systems fail to manage water that comes into contact with the door system under ambient conditions or under conditions of substantial wind driven water penetration.

### BRIEF DISCUSSION OF THE INVENTION

In light of these apparent problems in the art, the invention claimed herein provides an improved entry door system that comprises an easily adjustable door slab that can be positioned to maintain an adequate weather seal, an threshold member that provides a base for a weather seal for the door, a water management system comprising the threshold member and end cap corner key system that prevents penetration of water to the interior of the house and protection for wooden framing members in the door system from the adverse effects of water.

The entryway door systems of the invention typically have a frame and a slab hingedly mounted on the frame. The interface between the slab and the frame is sealed using a weather strip system that prevents penetration of weather during use. The weather strip is typically placed at the periphery of the frame. The frame of the entryway system additionally comprises a threshold member. The threshold member is typically a horizontally positioned extruded thermoplastic or aluminum member having an internal water tank structure installed between generally upright jamb members. The threshold is adapted for the stress of installation into the system of the invention and for traffic placing stress on the upwardly facing surface. The water is managed or maintained within the threshold using end cap corner key seal units that, when installed on the threshold, form an intact water system that can manage water that penetrates the door system. The end caps corner keys are designed with multifunctional elements that seal the water tank, position the end caps corner keys on the threshold and provide support and attachment means for vertical framing members in the entryway system. The entryway system comprises a slab mounted on a hinge to form a door within the frame. The hinges used in the entryway system are adjustable both vertically and horizontally to ensure the slab matches the frame opening and the weather strip system.

### BRIEF DESCRIPTION OF THE DRAWINGS

FIG. 1 is an exploded view of jamb, end cap corner key and threshold system in combination with a vertical jamb-framing member in a typical door installation using the system of the invention. Individual items shown in FIG. 1 include an extruded threshold, a threshold end cap corner key and the vertical jamb member.

FIGS. 2-6 are various views of the transition block that receives the shim for the horizontal door adjustment purposes. The views display the exposed shim insertion portion of the transition block, a bottom view, a side view and a cross-sectional view.

FIGS. 7 and 7A are top views of the shim that cooperates with the transition block of the invention to obtain the horizontal adjustment of the door installation.

FIGS. 8-13 are various views of the two knuckle vertically adjustable hinge of the invention. The various views demonstrate the utility of the hinge including a lower support hinge, an upper supported hinge and the ability to adjust the height of the supported hinge to adjust the height of the door in door installation.

FIG. 14 is an isometric view of the dual-handed door used in conjunction with the threshold and frame of the invention. The door block can be used as either a right-handed or left-handed opening door in exterior entry door applications.

FIGS. 19 and 20 show an alternative embodiment of the water seal aspect of the end cap corner key.

FIG. 21 shows an alternative embodiment of the threshold 100 of the invention.

FIG. 22 shows detail of the weather strip anchor 215 which can act as a secure location in which the weather strip can be installed but cannot easily be removed.

FIGS. 23 and 24 show elongated end cap corner keys adapted for the elongated threshold 210 of FIG. 21.

FIGS. 25A, 25B and 25C show views of an end cap corner key having integral sealing means adapted to seal the end of the threshold 100 (see FIG. 1).

### DETAILED DESCRIPTION OF THE PREFERRED EMBODIMENTS

In the following description of the preferred embodiment, reference is made to the accompanying drawings which form a part of this specification hereof, and in which is shown by way of illustration, specific embodiments of the invention in practice. Other embodiments may be utilized in and structural changes may be made to the illustrated elements without departing from the scope of the present invention. Generally common reference numerals are used to indicate the same element in different drawings.

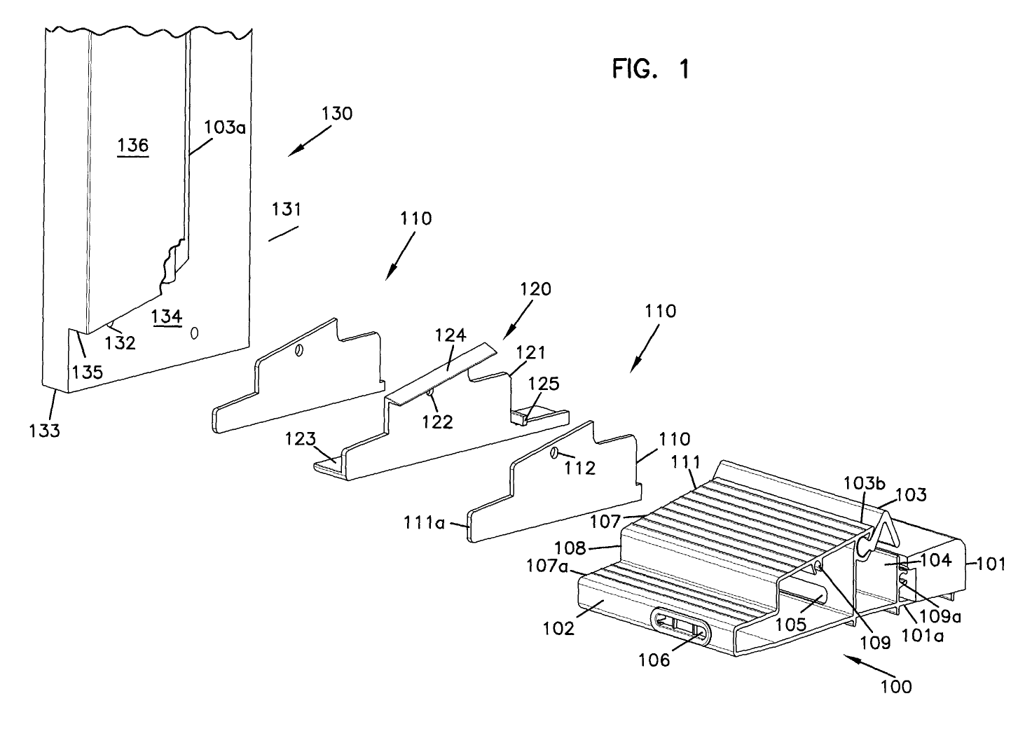

FIG. 1 generally illustrates the construction of the threshold, weather strip, gasket, end cap corner key, and sash or frame construction of the door of the invention. The exploded view of FIG. 1 demonstrates the use of the transitional end cap corner key 120 to form a mechanically secure joint between the vertical side jamb or sash 130 and the threshold 100. When assembled, the gasket 110 forms a water tight seal as the edge 111 of the threshold 100 matches the matching edge shape 111a of the gasket 110. In one option the end cap corner key can have an over molded sealant add-on amount of a resilient composition on the edges and surfaces acting to seal the end cap corner key to moisture by sealing the vertical plane of the end cap to the threshold. A variety of sealant materials can be used including rubber, silicone, urethane and other resilient materials. The end cap corner key 120 mechanically maintains an adequate watertight joint when installed on the threshold 100 holding the gasket 110 in place on the edge 111. The matching edge 111a forms a water tight seal on the entirety of the periphery of the threshold edge 111. A matching gasket end cap corner key 120 and vertical jamb 130 is installed on the opposite end of the threshold 100. The frame of the door is typically completed by joining the tops of the mated jambs 130 with a top plate (not shown). The threshold 100 of the invention typically is made from an extrudable material including metals, plastic, composites and other materials. On the threshold, an interior trim piece 101 is placed upon a trim stage 101a coextruded into the threshold 100. On the opposite exterior portion of the threshold 100 is an exterior edge 102 that contains an exterior drain and grille 106 that permits the interior water tank 104 to drain to the exterior of the threshold and dwelling through the internal threshold drain 105. This combination of tank 104, internal drain 105 and exterior drain 106 permits the threshold of the invention to maintain an adequate barrier to the penetration of wind driven (up to approximately 35 to 40 mph) rain or water through the threshold at a wind driven pressure of about 3 to 3.5 lb-ft.⁻². The column of water buildup in tank 102 provides a column or head of water that causes a difference in pressure resulting in water exiting from threshold 102 from tank 104 and through drains 105 and 106. This feature allows drain operation as the system experiences wind speeds of approximately 35 to 40 mph. Alternatively, by deepening the tank 104, water penetration resistance to wind driven rain at higher wind speeds can be achieved. As the pressure provided by the wind to the threshold is released, any water penetrating the system, collecting in the tank 104 simply drains from the threshold through the interior drain 105 and the exterior drain 106. A water tight seal between the threshold 100 and frame 130 of the invention is maintained using a V-shaped weather strip 103 in the horizontal plane of the threshold and 103a in the vertical plane of the jamb. When the slab (not shown) is closed against the horizontal weather strip 103 and the vertical weather strip 103a, weather tight and substantially air tight seal is formed as the V-shaped weather strip is compressed against the threshold 100 or the vertical jamb 130. At the transition of the vertical weather strip 103a to the horizontal weather strip 103, the bottom of the strip 103a is notched to permit the weather strip 103 to fit into and seal the corner of the frame to the movement of cold air or moisture into the interior of the door. When the door is closed the horizontal strip is compressed and as a result moves in the vertical dimension.

In addition to compression sealing the door, the horizontal strip can overlap the vertical strip and can be used in an overlapping form using the pressure of the closed door to form a seal at the overlap. Additionally, the vertical strip and the horizontal strip could be mitered with a straight or curved mitered joint to seal when compressed by the door. Further, a one piece part that can be inserted into the horizontal threshold and the vertical jamb can act as a seal requiring no interaction between the horizontal and vertical member. Additionally, the vertical member and the horizontal member in the weather strip structure can include a end cap corner key for the purpose of joining the horizontal to the vertical members. When using a corner key, the interface between the horizontal and the vertical member can be mitered or the corner key can form the corner portion of the joint.

This motion presses the horizontal strip against or overlaps the seal over the bottom portion of the vertical strip and forms a tight seal against infiltration of cold and moisture. The weather strip 103 and the threshold 100 is maintained using a weather strip attachment means 103b comprising, in FIG. 1, a recessed portion sized to receive an oversized portion of the weather strip that maintains a secure attachment of the weather strip 103 to the threshold 100. A replacement weather strip can be used that has a barbed insert to hold fast after replacing a worn unit. Any means to fix the seal in the joint can be used. The upper portion of the threshold 100 comprises a tread surface 107 and 107a. Between the tread surface 107 and the tread surface 107a is a storm door stop 108 that can form a support location for the base of the storm door installed on the door frame of the invention. The tread surfaces 107 and 107a can be ribbed for safe and secure step of a user. Tank 104 can be filled with a material that prevents the tank from being filled of debris from the exterior or from construction debris on the interior. Preferred materials for this purpose include large cell open cell foamed materials, rolled mesh structures and other materials of high porosity that can pass water but excludes debris from the water tank.

A water seal gasket 110 is placed between the open end of the threshold 100 and the end cap corner key 120. The gasket 110 has a periphery or matching edge shape 111a that is shaped to conform with but preferably extend past the perimeter of the open end or open edge 111 of the threshold 100 to obtain a tight seal. The matching edge shape 111a contacts the corresponding edge 111 of the threshold forming a water tight seal around the open end of the threshold 100. The gasket 110 is maintained against the open end of threshold 100 using the end cap corner key 120. The end cap corner key 120 has a shape that matches the matching edge shape 111 of the gasket and the open end of the threshold 100. The end cap corner key is assembled with the threshold using a fastener which passes through a fastener aperture 122 into a fastener boss 109 in the threshold 100. The end cap corner key 120 of the invention can be aligned to the threshold 100 to maintain a matching edge again that preferably extends past the perimeter (especially on the bottom) match between the edge shape 121, the matching edge shape 111a of the gasket 110 and the open end or edge of the threshold 100 using alignment means. Such alignment means can include alignment tabs or flanges that, when located on the threshold 100, positions the end cap corner key 120 in exactly the right location to maintain a water tight seal with the gasket 110. Exemplary alignment means include alignment flange 124 which is placed above and against the tread surface 107 of the threshold 100 providing vertical alignment of the end cap corner key 120 of the invention. Alignment tab 125, when placed against the appropriate portion of the threshold of the invention provides a horizontal location of the end cap corner key against the gasket 110 and threshold 100. The end cap corner key of the invention can comprise a horizontal member parallel to the rough floor comprising a support structure 123. The support structure is shaped and configured to match the diameter of the base portion 133 of the jamb 130. The jamb 130 rests on the base 133 upon the support flange 123. The support flange 123 can have fastener apertures (not shown) formed in the flange for permitting the passage of a fastener through the flange into the base 133. The combination of the sash or jamb 130 and the threshold 100 with a top plate (not shown) and a second jamb or frame forms the complete doorframe. The side jamb comprises an interior edge 131 that can act as a nailing surface for interior trim. The jamb 130 also comprises a stop portion 136 that acts as an installation location for the V-shaped weather strip 103a (can be of any shape including a bulb, foamed bulb or block) and acts as a stop for the door in a closed position. The jamb 130 also comprises a surface 134 that is brought into contact with the end cap corner key 120 for the purpose of maintaining the integrity of the frame. A fastener (not shown) can be passed through aperture 132 of the jamb which then passes through aperture 122 of the end cap corner key and, in turn, through the gasket aperture 112 into the screw boss 109 of the threshold to maintain an intact jamb threshold unit. The overlapping portion 135 of the stop 136 extends over the alignment flange 124 and the associated portion of the threshold 100. The overlapping portion 135 adds stiffness and a neat, finished appearance to the assembled frame.

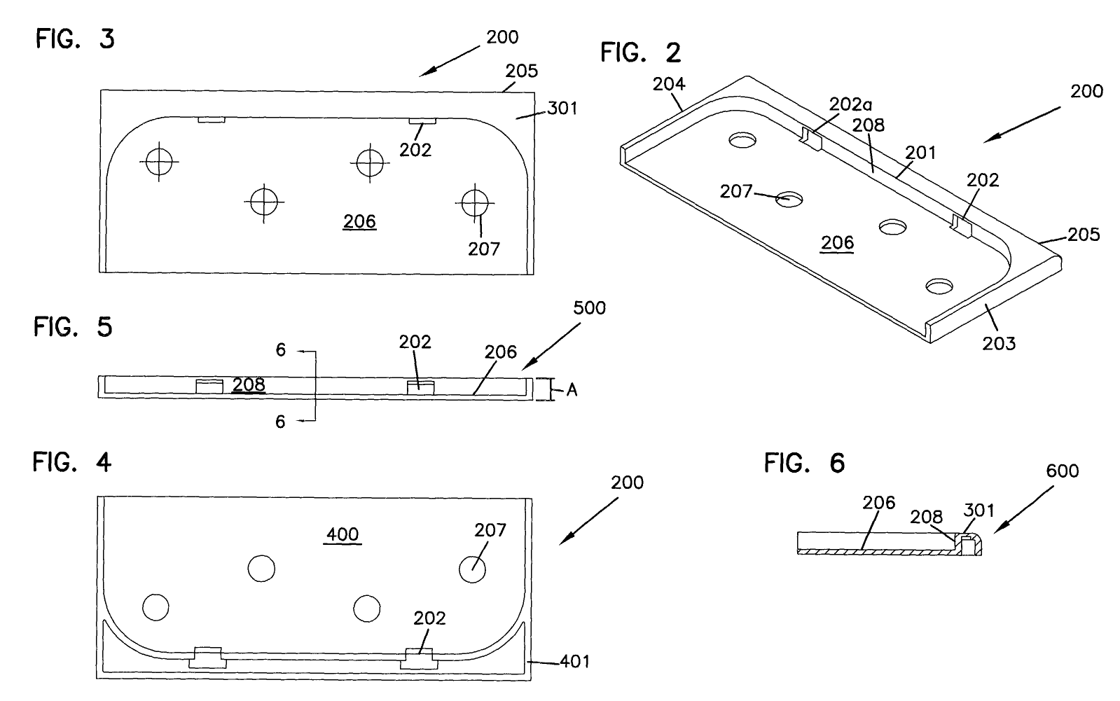

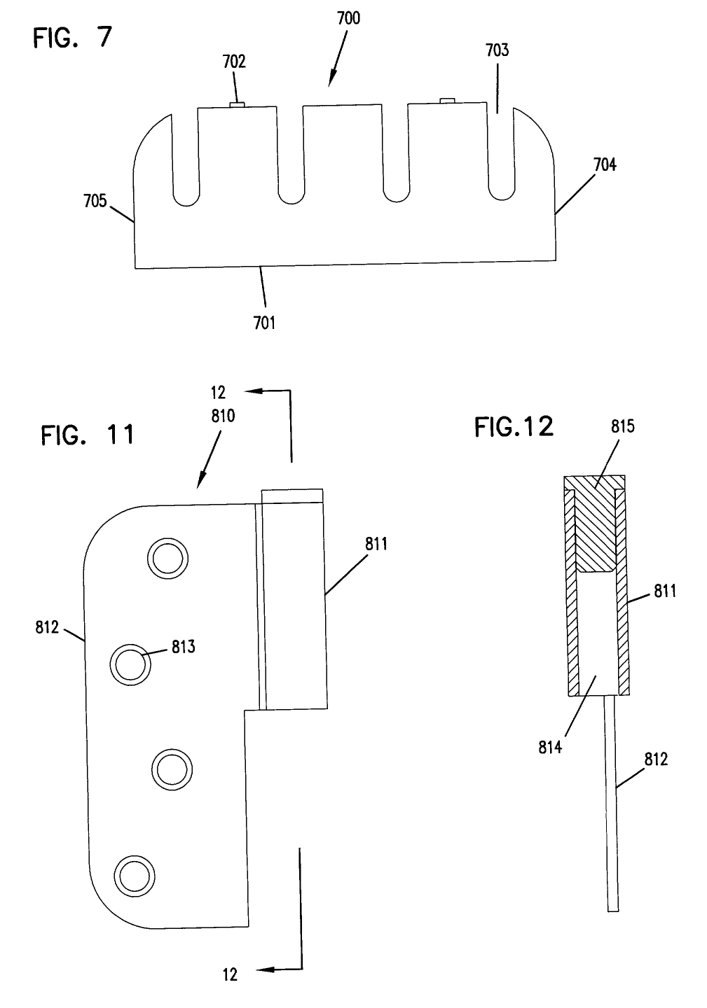

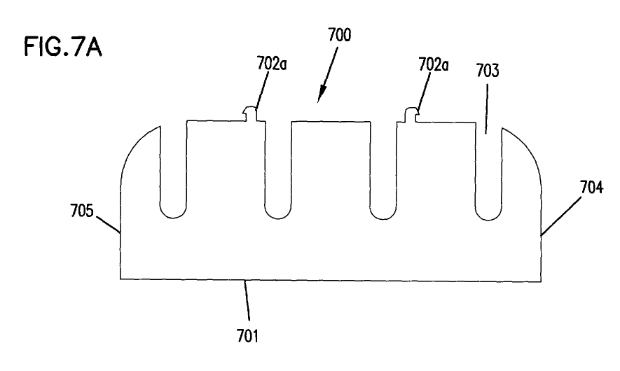

FIGS. 2-6 are various views of the transition block for the shim adjustment of the invention. The transition block is installed in a recess in the door slab, the horizontal adjustment occurs as a shim is placed between the hinge and the transition block. Further, the door slab can be installed as a right handed or left handed door depending on the orientation of the hinge side. Since the transition blocks can be installed in either a right handed or left handed aspect, the door slab and cooperating transition blocks can be installed as desired. FIG. 2 shows an isometric view of the shim insertion portion of the transition block base 200 of the invention. The transition block 200 includes a shim installation location 206 surrounded by a shim edge guide 201. The shim edge guide 201 contains shim tab apertures 202 and 202a into which the tab 702 of shim 700 (see FIG. 7) are inserted for secure temporary installation. The transition block base 200 for the shim 700 can be installed in either a right handed or left handed version. When installed in a right handed version, the transition block is installed with the top 204 installed in the upper portion of the recessed portion of the door block. Alternatively, if the door is to be installed in the opposite handed version, the transition block is installed with the top portion 203 installed in the upper portion of the recessed portion of the door block (not shown). The transition block 200 has an edge 205 that matches the shape of the recessed portion in the door. Preferably, in a metal door or slab, the transition block obtains a rectangular profile, however, the transition block can obtain any arbitrary shape that can contain the shim and hinge. The transition block 200 is installed into the door slab using a fastener (not shown) that passes through fastener aperture 207 and the shim aperture 703 of shim 700 (see FIG. 7) to fix the door slab in the frame.

FIG. 3 is a top view of the transition block 200 of the invention. The top view shows the installation surface 206 for the shim or shims, the fastener aperture 207, the shim tab insertion aperture 202, the door matching edge 205 and an upper surface 301 of the transition block. Once installed, the hinge surface (not shown) and the transition block surface 301 form a relatively flat coextensive surface. However, it should be well understood that, depending on the number of shim or shims placed between the installation surface 206 and the hinge surface (not shown), the dimension from the top of the hinge to the installation surface 206 can vary somewhat obtaining a greater or lesser difference from the surface 301 to the top of the hinge.

FIG. 4 is a bottom view of the transition block 200 of the invention. In FIG. 4 is shown the hidden side of the transition block 400, fastener aperture 207, the shim tab insert 202 and a base support edge 401 that supports the transition block 200 when installed in a recessed portion of the door.

FIG. 5 is a side view 500 of the transition block 200 of the invention. The shims (see FIG. 7) are inserted onto installation surface 206 having the installation tabs 702 of the shims inserted into tab aperture 202. The periphery of the shim is installed against the wall 208 of the transition block 200. Preferably the shim covers the entirety of the installation surface 206.

FIG. 6 is a cross-sectional view 600 of the transition block 200 of the invention. FIG. 6 shows the installation surface 206 for the shims (see FIG. 7) of the invention. The shims are installed covering substantially the entirety of installation surface 206 and resting against the surface at 208 of the transition block 200. The surface 301 of the transition block 200 of the invention is also shown.

FIG. 7 is a top view of a typical shim profile 700 of the invention. The shim can be used to adjust the door in the jamb or the slab. In FIG. 7, the shim 700 is shown. The shim has a thickness that can range from about 0.5 to about 3 millimeters (not shown). A view of the shim profile without showing its thickness is provided. The shim can be installed in a right handed or left handed version of the transition block 200 of the invention as described previously. In one installation, the top of the shim comprises top 704 while in the opposite handed installation, the top comprises top 705. FIG. 7 further shows installation tabs 702, fastener apertures 703 and a periphery 701 that matches the installation surface 206 of transition block 200.

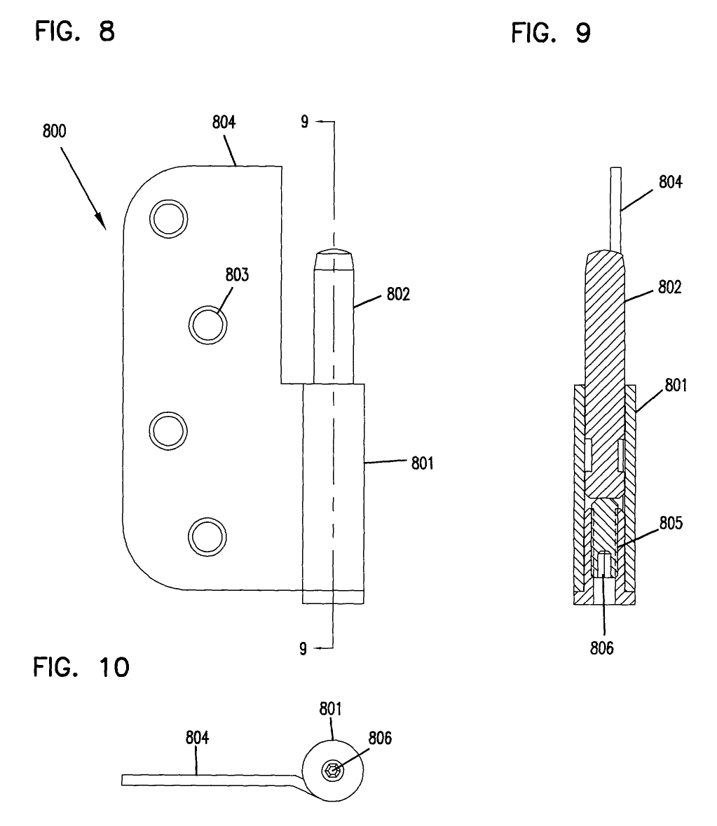

FIG. 8 is a side view of the lower portion of the two knuckle hinge 800 of the invention. The hinge can be installed in a right handed or left handed installation depending on the orientation of the hinge portion. As shown, the hinge is installed in a left handed opening view. The opposite orientation provides a right handed opening. Horizontal adjustment can be achieved with a mechanical adjustment integral in the hinge.

FIG. 7a shows an alternate embodiment of tab 702. In certain embodiments, the tab can be manufactured with a toothed tab 702a that can engage and hold the transition block 200 using the toothed insert to hold the tab in the block. The shim tab 702a having the toothed tab or modified structure can act to lock the shim 700 into the transition block 200 by engaging the shim tab insertion aperture 202 to mechanically fix the shim 700 in the transition block 200.

In FIG. 8, the hinge 800 includes a hinge plate 804 containing fastener aperture 803 to install the hinge plate 804 and hinge 800 in the transition block 200 of the invention. In such an installation, a fastener passes through aperture 203 through shim 700 and transition block 200 into the jamb (not shown). The upper hinge 810 is installed in the door edge. The door comprises the upper hinge 810 that rests upon pin 802 of the hinge 800. After the hinge, shim and block are assembled in the door and jamb respectively, the upper hinge 810 (see FIGS. 11 and 12) is supported by the lower hinge 800 and hinge pin 802. Hinge pin 802 is inserted into the barrel or upper portion 811 of the two knuckle hinge 810 of the invention. Depending on the perspective of the view, the upper portion 810 on the door is placed over the hinge pin 802 or the pin 802 is inserted into the barrel or upper (or insert) portion 811 of the upper portion hinge 810. Once inserted, the upper portion 810 on the door can rotate upon pin 802 in the jamb through the full motion required in appropriate door operation. Pin 802 is assembled into the lower portion 804 of the two knuckle hinge 800 of the invention using the pin support 801. The pin support 801 surrounds the pin 802 and provides an installation location for a height adjustment means 805 that adjusts the height of the door or the y-axis of the door for appropriate installation purposes.

FIG. 9 shows a cross-section of the hinge 800 of the invention. The cross-section shows the upper portion of the hinge plate 804, the hinge pin 802 formed inside the hinge pin support 801. Hinge pin 802 is supported by an adjustment structure 805 held within the pin support 801. The height adjustment means 805 can be moved in the vertical dimension for a distance of up to about 6 millimeters full range, thus adjusting the pin 802 in the pin support 801. Since the upper portion of hinge 810 rests on the hinge pin 802, the position of the pin 802 determines the height of the upper portion of the hinge. An adjustment tool such as an Allen wrench (not shown) can be inserted into the an adjustment tool location including an Allen wrench socket 806 and turned to adjust the height of the hinge adjustment 805 and the hinge pin 802.

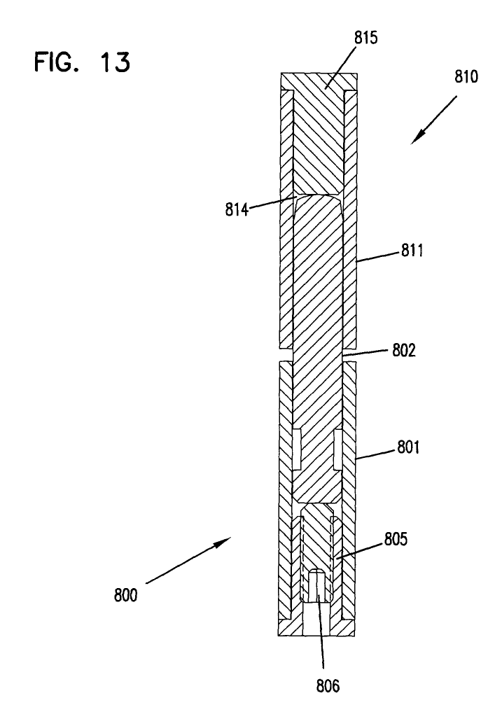

FIG. 10 is a bottom view of the hinge 800 of FIG. 8. FIG. 10 shows the hinge plate 804, the pin support 801 and the Allen wrench socket 806 exposed in the bottom portion of the support 801.

FIGS. 11 and 12 show the upper portion 810 of the two knuckle hinge of the invention. In FIG. 11, upper portion hinge 810 of the two knuckle hinge of the invention contains hinge plate 812 containing fastener apertures 813 for hinge installation. The pin insertion knuckle 811 of the hinge is shown. The hinge pin 802 is inserted into the hinge pin insert 811 to form the hinge. FIG. 11 is a side view cross-section of the pin insert 811 of the invention. In FIG. 12, the insert space 814 for hinge pin 802 is shown surrounded by the pin insert or wall 811. The pin 802 rests on stop 815 inserted into the upper portion of the pin insert or 811. The hinge plate 812 is also apparent in FIG. 12.

FIG. 13 is a cross-section of the assembled hinge taken through the hinge pin 802. Pin 802 is shown inserted into pin insert wall 811 and resting against stop 815. The pin 802 is inserted into the insert portion 814 and fills substantially the entirety of the interior space. The upper portion of the hinge 810 rotates around pin 802. Pin 802 is fixed in lower part of the two knuckle hinge 800 and is enclosed by pin support 801. Pin 802 rests on the adjustment 805 which is held within the lower hinge 800. The adjustment 805 can be moved in the vertical or y-direction using the Allen wrench socket insert 806. As the adjustment 805 is inserted by the Allen wrench inserted into socket 806, the adjustment moves in the vertical or y-direction to adjust the height of the hinge overall.

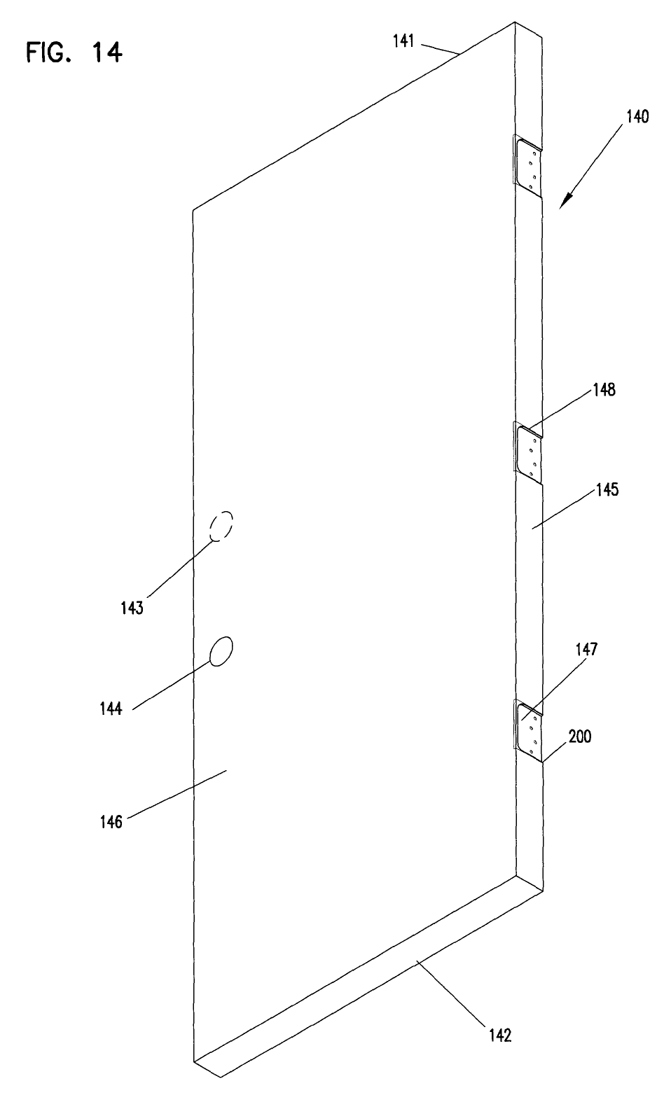

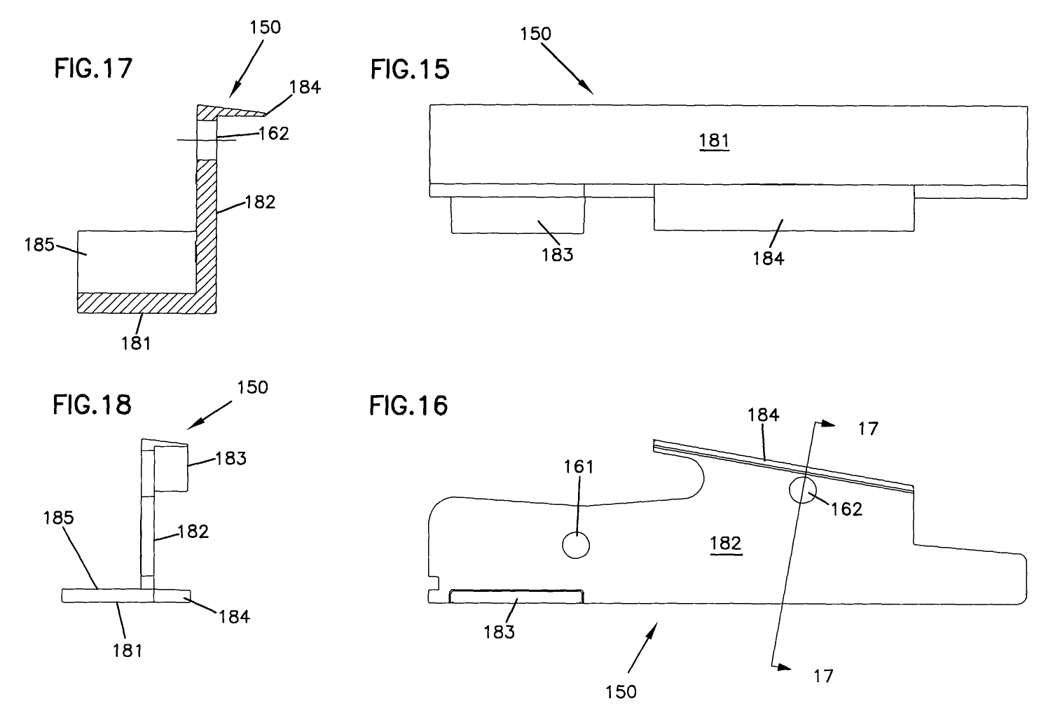

FIG. 14 shows an isometric view of a door or door slab of the invention. FIG. 14 demonstrates the ease of installation of the door hardware including lock sets, handles, transition blocks and hinges during the installation of the door or slab. In the door or slab 140 is shown a top 141, a bottom 142, a hinge mounting surface 145 and a side 146 that can act as either an interior or exterior side depending on the orientation of the hinges. In FIG. 14 are shown an aperture 144 and an aperture (in phantom) 143. Aperture 144 is positioned for the installation of the handle or lockset (not shown) that can be used to operate the door, preferably as an entry door. Both mortised and bored locksets can be used. Aperture 143 is an additional aperture that can be used for the installation of a deadbolt lock, a keypad entry system, security systems or other optional installations. Surface 146 can act as an exterior surface of the door when the door is right hand hinged as is defined by the installation of the hinges. The transition blocks and hinges are installed into the hinge surface 145 at locations for the hinge and transition block 148 that are typically formed into a metal door using components shaped to form the location without machining. Alternatively in a wood or fiberglass door, the door can be mitered using conventional router and bit or using hand tools to form the appropriate shape. In hinge surface 145 is shown three installations of the transition block 200. Additionally, in FIG. 14 is shown hinge 147 installed with transition block 200 in the hinge surface 145. The door can be converted into a left hand hinged door simply by reversing the installation of the transition block 200 and the hinge 147.

FIGS. 15 through 18 are various views of an end cap corner key of the invention. FIGS. 15 through 18 show one embodiment of the end cap corner key useful in attaching the threshold structure to the jamb structure. The end cap corner keys are engineered to provide a base upon which the jamb can rest after installation. The end cap corner key also contacts the jamb in a vertical plane and provides an attachment location for both the jamb and the threshold member. The end cap corner key of the invention also comprises installation tabs that interact with the threshold member to accurately position the threshold against the vertical member of the end cap corner key for installation ease and assembly efficiency. A side view of the end cap corner key embodiment of the invention is shown in FIG. 16. In FIG. 16, the upright planar member 182 is shown. In FIG. 16, the exposed upright member 182 is the surface of the end cap corner key which is installed against the threshold member using alignment tabs 183 and 184 which contact the interior surface of the threshold (not shown) and position the end cap corner key accurately onto the threshold member. In installing the end cap corner key, fasteners are inserted through fastener apertures 161 and 162 which extend into fastener or screw boss structures (not shown). Such screw bosses are shown in FIG. 1 at 109 and 109a. FIG. 15 is a top view of the end cap corner key of the invention. In FIG. 15, the base surface 181 of the end cap corner key 150 is shown. In the bottom view, the alignment tabs 183 and 184 are also shown extending from the vertical member 182. The alignment tabs 183 and 184 must extend from the end cap corner key 150 into the threshold member (not shown) in order to ensure proper alignment. FIG. 17 is a cross-sectional view of the end cap corner key in FIG. 16 at the line as shown in FIG. 16. In FIG. 17, the end cap corner key 150 shows alignment tab 184, fastener aperture 162, vertical surface member 182 and the upper surface 185 of the base portion 181. FIG. 18 is an end view of the end cap corner key of FIG. 16. In FIG. 18, the end cap corner key 150 is shown with base portion 181, the top surface of the base portion 185, the alignment tabs 183 and 184 and the upright or vertical member 182.

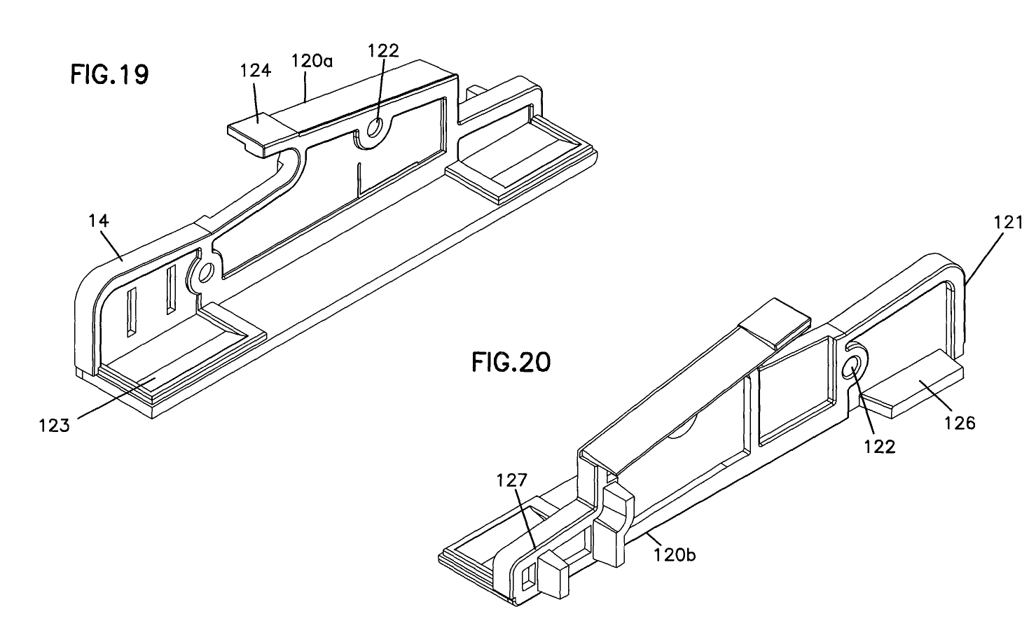

FIGS. 19 and 20 show an alternative embodiment of the water seal aspect of the end cap corner key. End cap corner key 120a or 120b of the invention. The end cap corner key 120 has a shape that matches the end 111 of the threshold 100. End cap corner key 120a or 120b is assembled with the threshold using a fastener that can pass through a fastener aperture 122 into a fastener boss 109 in the threshold 100. The end cap corner key 120a or 120b of the invention can be aligned to the threshold 100 to maintain an exact match between the edge shape 121 of 120a or 120b. The matching edge shape 121 contacts the corresponding edge 111 of the threshold forming a water tight seal around the open end of the threshold 100. Instead of using a gasket to form the water tight seal, the end cap corner key has installed on every edge that contacts the open end 111 of the threshold 120 with a resilient molded sealant. The molded sealant material is formed on each edge 126 of the end cap corner key 120a and 120b of the invention. Also shown in FIGS. 19 and 20 are support surfaces 123 and 126 that are formed in the end cap corner key 121a or 121b for the purpose of supporting the jamb 130 or supporting threshold 100. These support surfaces are formed from the corner key 121 and extend to and under the jamb 130 or the threshold 100.

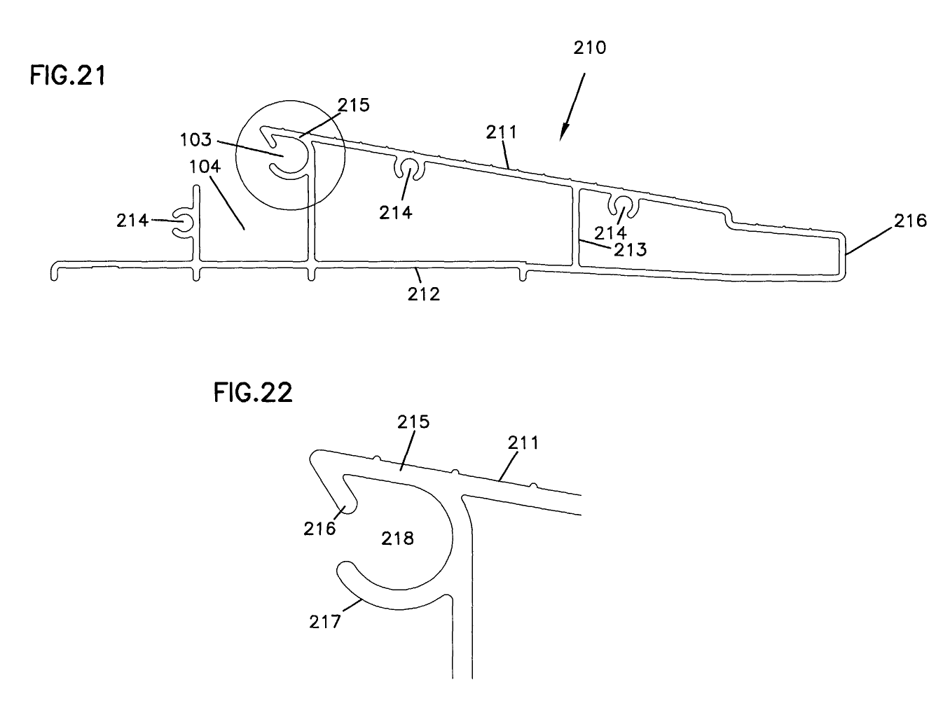

FIG. 21 shows an alternative embodiment of the threshold 100 of the invention. In FIG. 21, a threshold with an extended nose 216 is shown. This threshold is similar to the threshold of FIG. 1 but is extended in its external dimension. In FIG. 21, threshold 210 is shown having a tread surface 211. A threshold 210 is installed into a rough opening by placing the threshold support surface or base 212 into the rough opening (not shown). The threshold 210 and base 212 are positioned such that the door is correctly placed within the rough opening. The threshold 210, typically an extruded material including metal such as aluminum or aluminum alloy or structural thermoplastic can be extruded in a variety of shapes. In FIG. 21, threshold 210 is shown with a vertical support web 213 providing mechanical support and rigidity for weight placed on tread surface 211. The opposite surface from tread surface 211 contains one or more screw boss 214 installations that can be used to attach end cap corner key structure to the threshold. Tank 104 is shown in the threshold 210 for the purpose of providing a reservoir for the accumulation and drainage of water that can contact the threshold 210. Water from track 104 will drain from the tank through the threshold and will exit the threshold at nose 216 through apertures (not shown) in the threshold. FIG. 21 additionally shows weather strip anchor 215 which can act as an installation location for the weather strip 103.

FIG. 22 shows detail of the weather strip anchor 215 which can act as a secure location in which the weather strip can be installed but cannot easily be removed. The anchor comprises an internal enclosure 218 to enclose the anchor portion of the weather strip. Enclosure 218 is formed from curved lip 217 and tang 216. Curved lip 217 and tang 216 cooperate to permit the easy installation of the weather strip anchor into the space 218 but because of the geometry of tang 216, the anchor cannot easily be removed. Depending on the size of the anchor and the position of tang 216, the weather strip will be destroyed upon its removal requiring the installation of a new weather strip. The location of the tread 211 with respect to the weather strip anchor 215 is demonstrated in FIG. 22.

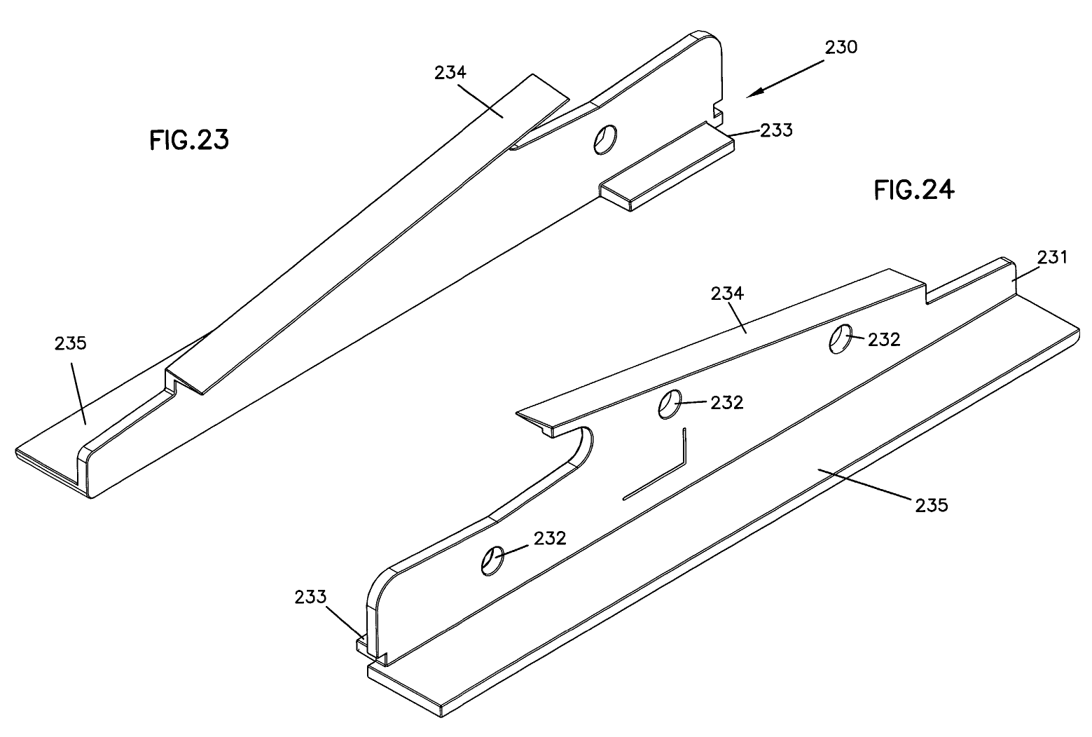

FIGS. 23 and 24 show elongated end cap corner keys adapted for the elongated threshold 210 of FIG. 21. In FIGS. 23 and 24 shown an end cap corner key for installation on the left hand side of the system of the invention as viewed from the exterior. A right and a left view of the elongated end cap corner key 230 of the invention is shown. The elongated end cap corner key 230 has an alignment tab 234 that aids in aligning the end cap corner key 230 with the elongated threshold 210. In vertical portion 231 of the end cap corner key 230 are placed apertures 232 through which fasteners are placed for joining the end cap corner key to the jamb and threshold (not shown). FIGS. 23 and 24 show support surfaces 233 and 235. Support surface 233 is used to support the threshold 210 or to permit alignment between the end cap corner key and the threshold 210 for the purpose of ensuring a secure and accurate installation. Support 235 permits the installation of the jamb with the end cap corner key and the threshold in a secure supported structure. Further, support surface 235 provides moisture barrier preventing moisture from wicking into the jamb (not shown).

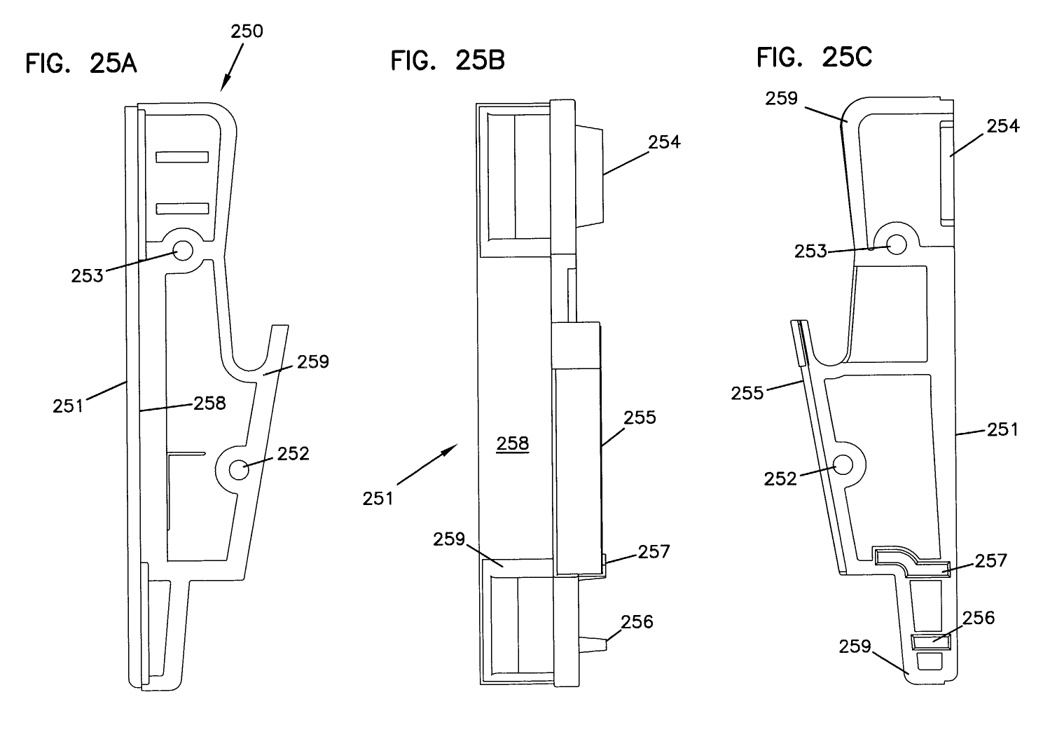

FIGS. 25A, 25B and 25C show views of an end cap corner key of the invention using integral sealing means. The end cap corner key 250 is similar to the key 120 of FIG. 1. While key 120 uses a separate gasket, key 250 uses integral sealing means 259. End cap corner key 250 comprises a base 251 that contacts the surface of the rough opening for the door (not shown) and additionally provides a base 258 supporting the jamb bottom. The key 250 is installed cooperating with the open end of the threshold (not shown) using installation guides 254, 255, 256 and 257. The guides can be inserted into matching insertion locations in the threshold to ensure that the key 250 profile matches the threshold and that the sealing means seal the open ends of the threshold. The seal maintains the integrity of the tank to accumulate water when necessary. The key 250 is attached mechanically to the threshold using fasteners (typically screws) using the fastener aperture 252 and 253. A perimeter seal 259 is formed on the key 250 using conventional technology. The seal is typically formed of a resilient material capable of compression sealing between the key 250 and the matching surface in the threshold. A typical threshold 100 can be sealed using the integral sealing means on end cap corner key 250. The perimeter seal 259 can be extruded, cut or pre-formed from gasket material or otherwise formed into the correct shape and placed onto the appropriate locations of key 250.

The foregoing description and drawings provide adequate basis for understanding the operation of the invention and the best mode. The invention, however, can take a variety of embodiments without departing from the spirit are appropriate scope of the invention. The invention resides in the claims hereinafter appended.

We claim:

1. An entryway system that can adjust a slab within a frame and maintain a sealed system to exterior weather when closed, the system comprising an entryway comprising:
(a) a frame comprising a peripheral weather strip having at a minimum a resilient weather strip positioned substantially on the entirety of both sides and the bottom of the frame, the frame bottom additionally comprising a threshold member joined to the frame with an end cap corner key positioned there between, the threshold forming a tank such that the threshold can accumulate and drain environmental water to the exterior of the frame; and
(b) a slab mounted on the frame with an adjustable hinge member, said hinge vertically and horizontally adjustable to sealingly match the slab periphery to the peripheral weather strip.

2. The entryway of claim 1 wherein the weather strip is positioned on the top of the frame.

3. The system of claim 1 wherein the weather strip is a V-shaped resilient weather strip wherein the base of the V-shaped weather strip acts as a hinge permitting sealing compression of the weather strip structure.

4. The system of claim 1 wherein the threshold comprises an extruded aluminum threshold having an drain exposed to the exterior, the threshold open ends sealed with the end cap corner key, the end cap corner key comprising sealing means to prevent water leakage from the ends of the threshold, flange means extending from the end cap corner key positioned to support a vertical member of the framing in the system and positioning means to ensure that the end cap corner key is correctly positioned on the hollow profile.

5. The system of claim 4 wherein the end cap corner key is sealed using a resilient seal.

6. The system of claim 4 wherein the seal comprises a polymeric elastomer.

7. The system of claim 6 wherein the polymeric seal comprises a foamed polymeric seal.

8. The system of claim 1 wherein the hinge is horizontally adjustable using a shim.

9. The system of claim 8 wherein hinge is adjusted by a shim in the door slab.

10. The system of claim 8 wherein hinge is adjusted by a shim in the jamb.

11. The system of claim 8 wherein hinge is adjusted by a mechanical adjustment in the hinge.

12. The system of claim 1 wherein the hinge comprises a two-knuckle hinge, the hinge is vertically adjustable.

13. The system of claim 12 wherein the two knuckle hinge has an upper knuckle and a lower knuckle, the upper knuckle being supported by a pin that is adjustable in the vertical dimension.

14. The system of claim 13 wherein the adjustable pin can move through an adjustment range of about 0.2 to 10 mm.

15. The system of claim 13 wherein the adjustable pin can move through an adjustment range of about 0.5 to 5 mm.

16. A threshold structure for an entryway door, the structure comprising an threshold assembly comprising a water drain system associated with a water tank, a weather strip associated with a mounting means for the weather strip, an interior base for a trim member, a trim member, the ends of the threshold assemblies sealed using a corner key end cap structure and a threshold gasket positioned therebetween to maintain the water tank integrity.

17. The threshold system of claim 16 wherein the threshold comprises extruded aluminum.

18. The threshold system of claim 16 wherein the trim member comprises a wooden member.

19. The threshold of claim 16 wherein the corner key end cap additionally comprises an extended support means and attachment means for a side jamb framing member.

20. The threshold of claim 16 wherein the water tank comprises a depth of less than about 25 millimeters that can maintain a water head with a depth of less than about 20 millimeters in response to a normal force from a wind velocity of 60 km-sec⁻¹.

21. The threshold of claim 16 wherein the sill gasket comprises a thermoplastic.

22. The threshold of claim 16 wherein the sill gasket comprises a foamed sill gasket.

23. The threshold of claim 16 wherein the interface between the corner key end cap and the side jamb framing and the interface between the corner key end cap and the threshold both contain sill gasket.

24. The threshold of claim 16 wherein the threshold comprises attachment means such that the corner key end cap can be assembled with the threshold and sill gasket using a fastener that interacts with the attachment means.

25. The threshold of claim 16 wherein the corner key comprises positioning means such that the corner key is fixed at a single location on the threshold with the fastener.

26. An adjustable hinge for an entryway door system, the adjustable hinge comprising:
(a) a shim assembly comprising a shim frame and at least one shim insert; and
(b) a two knuckle hinge with an upper knuckle and a lower knuckle, the upper knuckle supported and hingedly mounted on a pin extending vertically from the lower knuckle, the pin having adjustment means in the vertical direction.

27. The hinge of claim 26 wherein the shim has a thickness of at least 1 millimeter.

28. The hinge of claim 26 wherein the hinge system comprises a shim base and two or more shims.

29. The hinge of claim 26 wherein the shim frame comprises a peripheral edge stop holding the shim within the frame.

30. The hinge of claim 26 wherein the hinge frame is a rectangular frame adapted for installation into a rectangular opening in a door frame structure.

31. The hinge of claim 30 wherein the hinge frame has a thickness of about 1 to 3 millimeters.

32. The hinge system of claim 26 wherein the adjustable pin is adjustable through a range of about 0.1 to about 6 centimeters using a screw adjustment.

33. The hinge system of claim 26 wherein the adjustable screw driven by an Allen wrench.

34. A threshold system in an entryway system that can maintain a seal of an interior space to weather from an exterior, the threshold system comprising:
(a) threshold having a tank and a drain exposed to the exterior;
(b) a jamb; and
(c) an end cap corner key positioned between the jamb and the threshold, said jamb comprising sealing means between the end cap and the threshold that ensures integrity to a tank formed within the threshold sealed by the end cap;
wherein the end cap comprises a support extending from the end cap corner key that forms a barrier to the passage of environmental water into the jamb, said end cap further comprising an alignment tab that cooperates with threshold to ensure the appropriate installation of the end cap corner key.

35. The threshold system of claim 34 wherein the threshold comprises extruded aluminum.

36. The threshold system of claim 34 wherein the end cap corner key comprises one or more fastener apertures and the alignment tab cooperates with the tread surface of the threshold.

37. The threshold system of claim 34 wherein a gasket is placed between the end cap corner key and the threshold.

38. The threshold system of claim 34 wherein the end cap corner key comprises a molded sealant placed such that the molded sealant contacts an open end of the threshold to form a watertight seal.

39. The threshold system of claim 34 wherein the end cap comprises a support extending beneath both the jamb and the threshold.

40. An entryway system that can adjust a slab within a frame and maintain a sealed system to exterior weather when closed, the system comprising an entryway comprising:
(a) a frame comprising a header, a threshold and at least one jamb in the peripheral frame; and
(b) a slab mounted on the frame, said slab comprising a mortised hinge installation location, said location comprising a shim and a hinge, the hinge adjustable in the vertical dimension, comprising a two knuckle hinge structure;
wherein the frame comprises a threshold and a corner key, the threshold comprising a trim member, a water tank sealed by the end cap corner key using sealing means between the end cap corner key and the threshold.

41. The system of claim 40 wherein the hinge is horizontally adjustable using a shim.

42. The system of claim 40 wherein the hinge is adjusted by a shim in the door slab.

43. The system of claim 40 wherein hinge is adjusted by a shim in the jamb.

44. The system of claim 40 wherein hinge is adjusted by a mechanical adjustment in the hinge, horizontally and/or vertically.

45. The threshold system of claim 16 wherein the threshold comprises aluminum.

46. The threshold system of claim 16 wherein the extruded trim member comprises a wooden member.
